(19) United States
(12) Patent Application Publication
(10) Pub. No.: US 2026/0286768 A1
(43) Pub. Date: Sep. 24, 2026

(54) RAIN DEFLECTOR APPARATUS AND SYSTEM

(71) Applicant: STORM ARMOUR, INC., Miami Beach, FL (US)

(72) Inventors: Mark Fisher, Bal Harbour, FL (US); Todd Michael Glaser, Palm Beach, FL (US); Ronald Simkins, Miami, FL (US); David Kreps, Miami Beach, FL (US); Werner Blumenthal, Miami, FL (US)

(73) Assignee: STORM ARMOUR, INC., Miami Beach, FL (US)

(21) Appl. No.: 19/572,697

(22) Filed: Mar. 19, 2026

Related U.S. Application Data
(60) Provisional application No. 63/775,867, filed on Mar. 21, 2025.

(51) Int. Cl. E06B 7/26

(52) U.S. Cl. CPC E06B 7/26

(57) ABSTRACT

A rain deflector apparatus includes a plurality of panels configured to telescope relative to one another to adjust an overall width of the apparatus. Each panel includes a main body having a front face, a back face, and edges defining a bottom seal portion and a top sealing surface portion. The panels include mating features configured to constrain relative movement while permitting longitudinal translation between the panels. One or more attachment mechanisms are disposed on the panels and configured to secure the apparatus to a structure. When installed, the bottom seal portion and the top sealing surface portion are configured to engage corresponding surfaces to reduce intrusion of water by diverting water and debris away from an opening. In embodiments, a retention device includes a shaft portion insertable into an extruded mounting portion and a head portion configured to retain an accessory.

### CROSS-REFERENCE TO RELATED APPLICATIONS

This U.S. Non-Provisional Patent application claims the benefit of priority to co-pending U.S. Provisional Patent Application No. 63/775,867, filed on Mar. 21, 2025, which is incorporated by reference as if fully set forth herein.

### FIELD

The present disclosure generally relates to windstorm mitigation devices and, more specifically, to rain deflector apparatuses and systems configured to reduce water intrusion through structural openings.

### BACKGROUND

In high rise condominiums, townhouses, apartment buildings, and private residences there are no current practical and/or efficient ways to reduce the amount of water intrusion through the tracks of sliding glass doors during severe weather conditions. Hurricane-rated glass doors and windows are typically rated for projectile impact; however, such systems do not adequately address water intrusion associated with wind-driven rain.

Sliding glass doors commonly operate on tracks that include weep holes configured to allow accumulated water to drain under normal weather conditions. This is not the case in conditions with wind-driven rain. Under these conditions, weep holes do not function properly as the storm-force winds push the rainwater through the gaps between the sliding glass door and the track into the interior of the structure.

Commonly owned patent applications U.S. Ser. No. 17/428,113, Ser. No. 17/994,231, Ser. No. 18/416,241 and family applications and granted patents, describe systems that improve upon the existing state of the art for mitigating water intrusion. However, further improvements may be made with respect to apparatuses for attachment and retention of wind and rainstorm intrusion mitigation devices to existing structures, including but not limited to sliding door and window tracks and rails.

### BRIEF SUMMARY

In embodiments, a rain deflector apparatus comprises a plurality of panels including a central panel and at least one additional panel, the panels being configured to telescope relative to one another to adjust a width of the rain deflector apparatus. Each of the panels includes a main body having a front face, a back face, and a thickness defining a top edge, a bottom edge, a right edge, and a left edge. A bottom seal portion extends from the bottom edge of each of the panels, and a top sealing surface portion is disposed adjacent to the top edge of each of the panels. One or more attachment mechanisms are disposed on the back face of at least one of the panels between the top sealing surface portion and the bottom seal portion. The panels include mating features configured to constrain relative movement between the panels with respect to the top edges and the bottom edges while permitting longitudinal translation of the panels relative to one another. The rain deflector apparatus is configurable to be secured to a structure such that the bottom seal portion and the top sealing surface portion engage corresponding surfaces to reduce intrusion of water.

In embodiments, a retention device for use with a rain deflector apparatus including an extruded mounting portion comprises a shaft portion configured to be inserted into an end of the extruded mounting portion and a head portion coupled to the shaft portion and having a diameter greater than the shaft portion, wherein the head portion is configured to retain an accessory on the extruded mounting portion.

### BRIEF DESCRIPTION OF THE DRAWINGS

The accompanying drawings are included to provide a further understanding of the present disclosure and are incorporated in and constitute a part of this specification. The drawings illustrate exemplary embodiments of the disclosure and, together with the description, serve to explain the principles of the disclosure.

In the accompanying figures, like reference numerals refer to identical or functionally similar elements throughout the separate views. The accompanying figures, together with the detailed description below are incorporated in and form part of the specification and serve to further illustrate various embodiments and to explain various principles and advantages all in accordance with the present invention, in which:

FIG. 1 is a front perspective view of a rain deflector apparatus in accordance with an embodiment of the present disclosure.

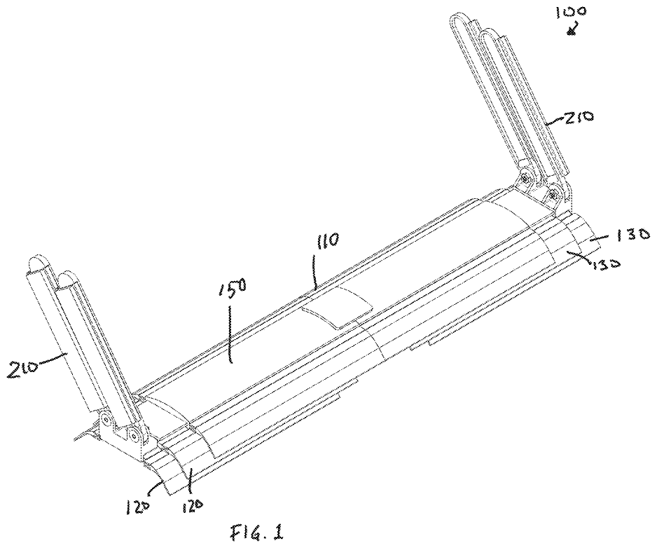

FIG. 2 is a back perspective view of the rain deflector apparatus of FIG. 1.

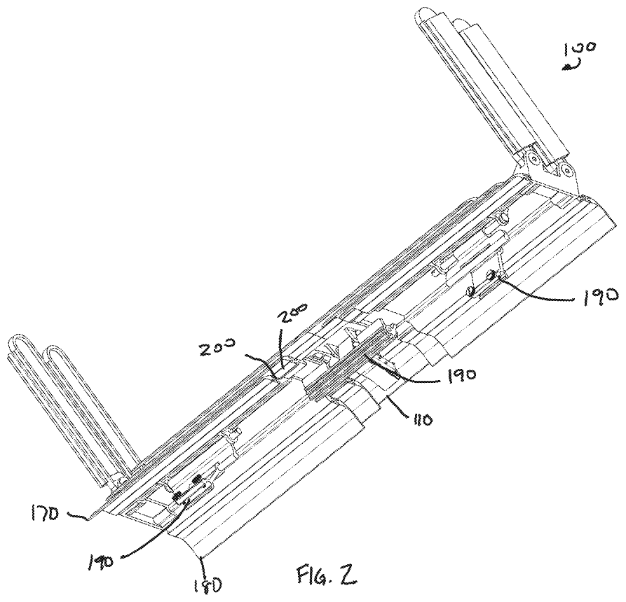

FIG. 3 is a side view of the rain deflector apparatus of FIG. 1.

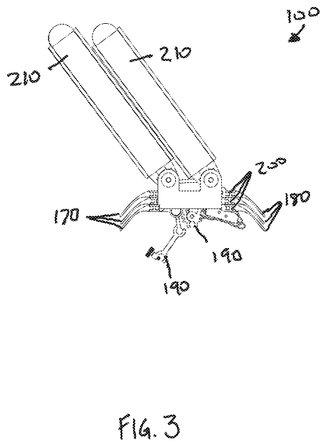

FIG. 4 is a front view of the rain deflector apparatus of FIG. 1.

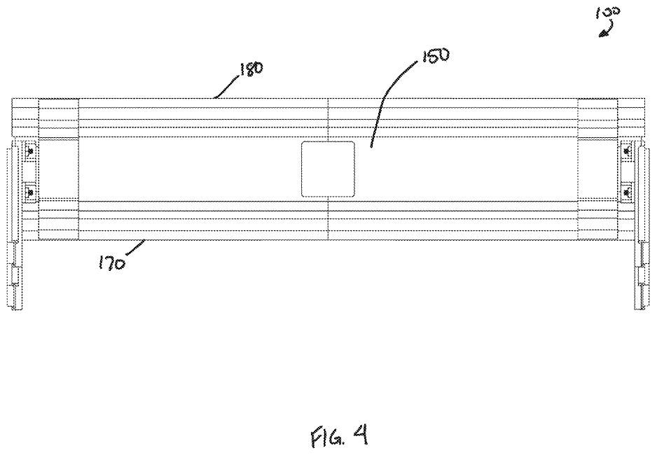

FIG. 5 is a top view of the rain deflector apparatus in a first configuration.

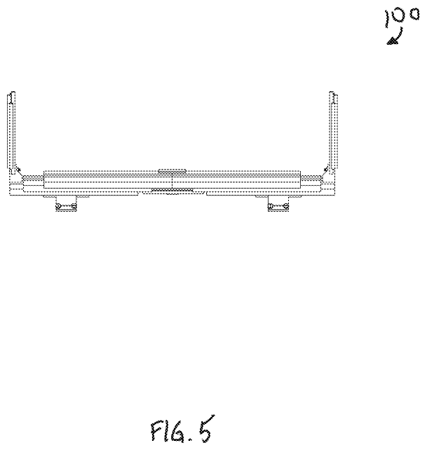

FIG. 6 is a top view of the rain deflector apparatus in a second configuration.

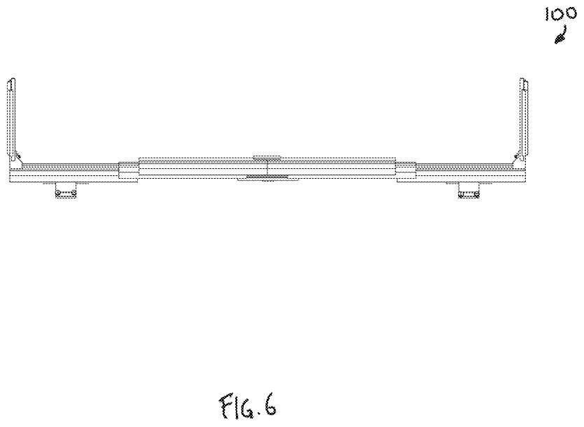

FIG. 7 is a front view of the rain deflector apparatus in a contracted configuration.

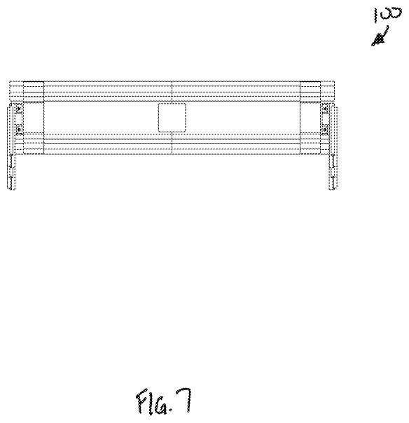

FIG. 8 is a front view of the rain deflector apparatus in a partially expanded configuration.

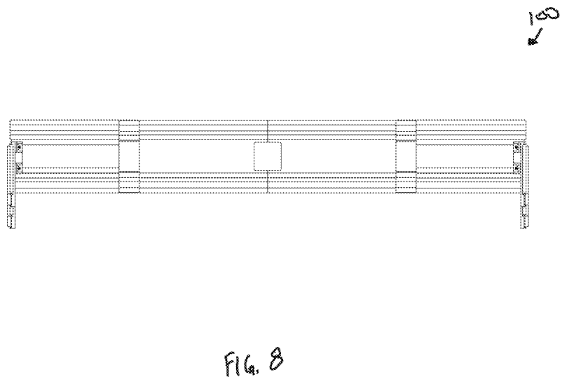

FIG. 9 is a front view of the rain deflector apparatus in a fully expanded configuration.

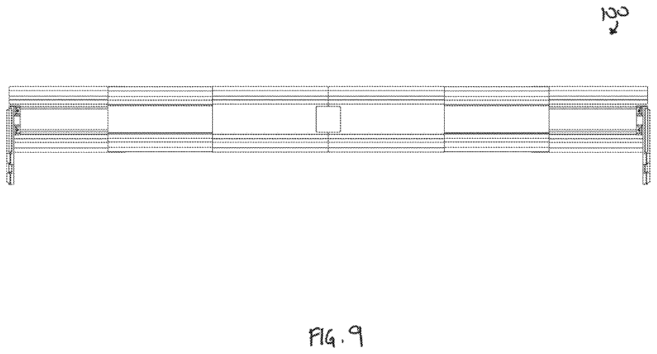

FIG. 10 is a perspective view of the rain deflector apparatus in a contracted configuration.

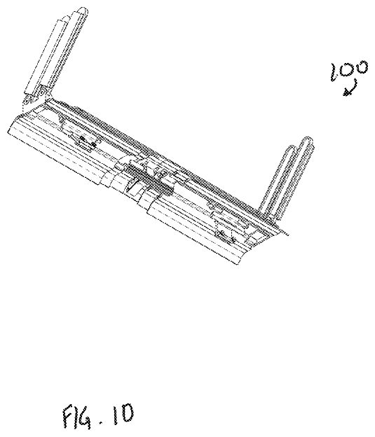

FIG. 11 is a perspective view of the rain deflector apparatus in a partially expanded configuration.

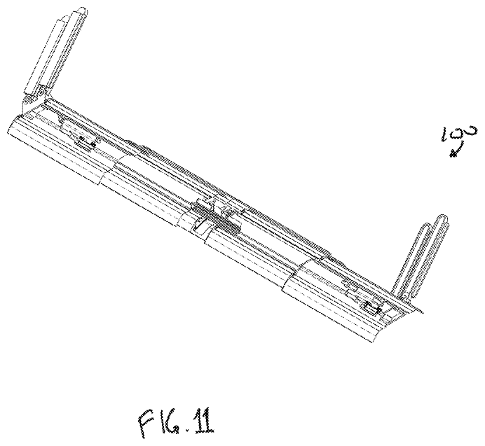

FIG. 12 is a perspective view of the rain deflector apparatus in a fully expanded configuration.

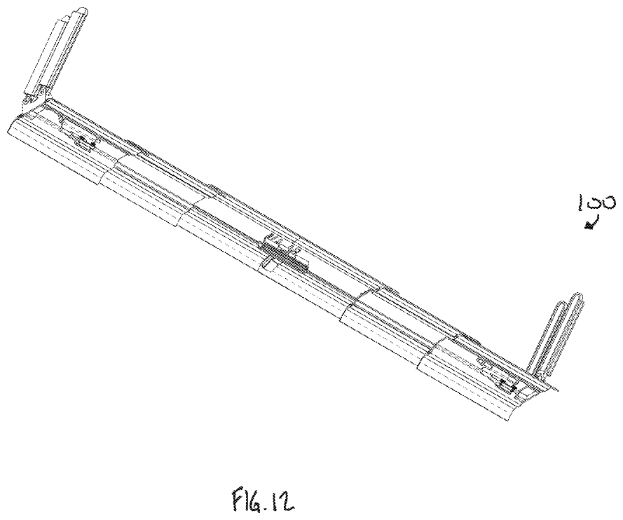

FIG. 13 is a side view of a rain deflector apparatus with extruded portions and retention devices.

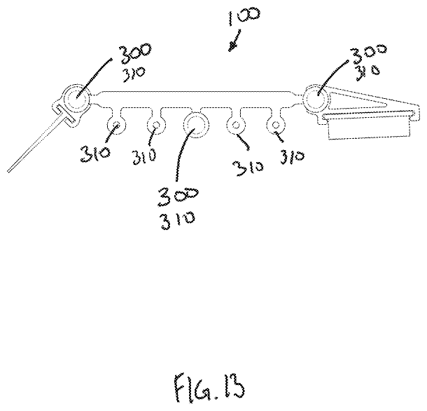

FIG. 14 is a partial perspective view of the rain deflector apparatus of FIG. 13.

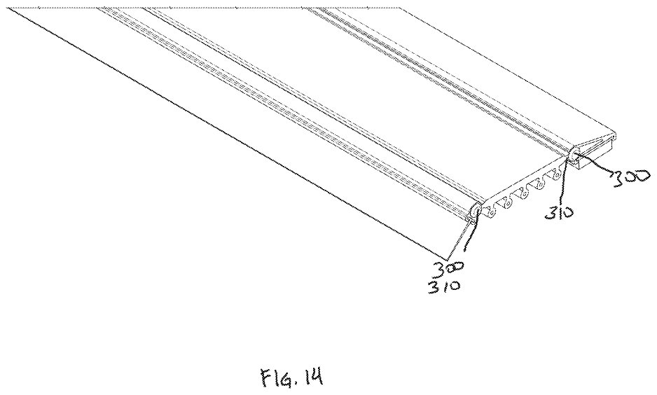

FIG. 15 is an exploded view of FIG. 14.

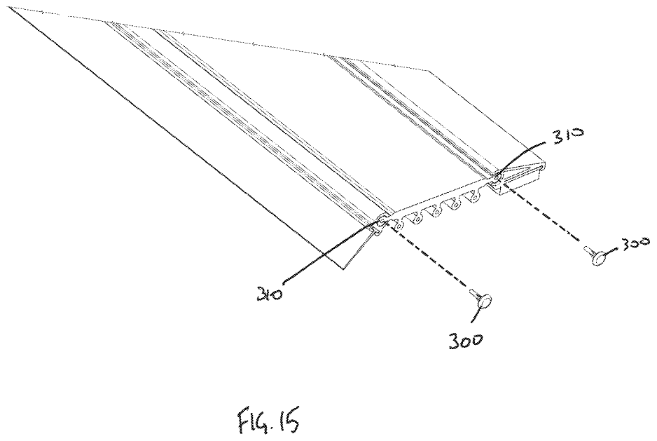

FIG. 16 is a top view of a retention device in accordance with an embodiment of the present disclosure.

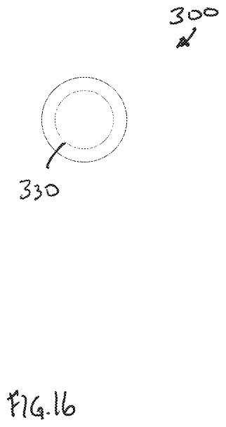

FIG. 17 is a side view of the retention device of FIG. 16.

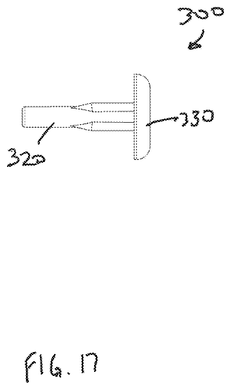

FIG. 18 is a perspective view of the retention device of FIG. 16.

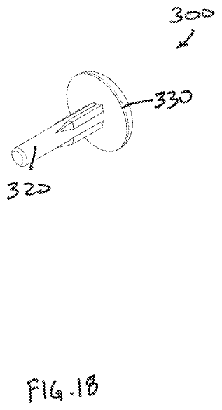

FIG. 19 is a bottom view of the retention device of FIG. 16.

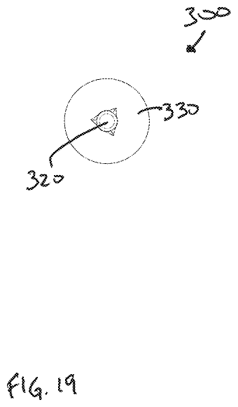

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DESCRIPTION

Before describing in detail embodiments that are in accordance with the present invention, though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

The present disclosure is not a literal description of all embodiments of the invention(s). Also, the present disclosure is not a listing of features of the invention(s) which must be present in all embodiments.

The present disclosure is not a literal description of all embodiments of the invention(s). Also, the present disclosure is not a listing of features of the invention(s) which must be present in all embodiments.

### Non-Limiting Definitions

The title of the present application and headings of sections provided in the present application are for convenience only, and are not to be taken as limiting the disclosure in any way.

The following non-limiting definitions are provided as a guide to interpreting the present invention:

The term “product” or “apparatus” means any machine, manufacture, and/or composition of matter, unless expressly specified otherwise.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc . . . when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

As used herein, the term “structure” is used to refer to any type of building or infrastructure, constructed object, or form susceptible to high wind and rainfall upon fenestrations. This can include, but is not limited to, sliding doors and windows in condominiums, single- or multi-family homes, office buildings, commercial building, industrial buildings, malls, stadiums, towers, structures related to or used for transportation, or traffic (including bridges), or energy- or power-related infrastructures. This term is also not limited to any particular material, construction technique, or style and can include fenestrations that are situated upon any surface, at any orientation, or other building construction features in which water may accumulate, such as a roof parapet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### Overall Configuration

Referring generally to the drawings, a rain deflector apparatus 100 is shown in accordance with embodiments of the present disclosure. The rain deflector apparatus 100 comprises a plurality of panels including a central panel 110 and at least one additional panel, the panels being configured to telescope relative to one another to adjust a width of the rain deflector apparatus 100.

Each of the panels includes a main body 150 having a front face 152, a back face 154, and a thickness defining a top edge 156, a bottom edge 158, a right edge 160, and a left edge 162. A bottom seal portion 170 extends from the bottom edge 158 of each of the panels, and a top sealing surface portion 180 is disposed adjacent to the top edge 156 of each of the panels.

One or more attachment mechanisms 190 are disposed on the back face 154 of at least one of the panels between the top sealing surface portion 180 and the bottom seal portion 170. The panels include mating features 200 configured to constrain relative movement between the panels with respect to the top edges 156 and the bottom edges 158 while permitting longitudinal translation of the panels relative to one another.

The rain deflector apparatus 100 is configurable to be secured to a structure such that the bottom seal portion 170 and the top sealing surface portion 180 engage corresponding surfaces to reduce intrusion of water.

### A. Overall Panel Assembly

The rain deflector apparatus 100 includes a plurality of panels including a central panel 110 and one or more additional panels configured to telescope relative to the central panel 110. In embodiments, the additional panels include a left panel 120 and a right panel 130.

In embodiments, one or more intermediary panels 140 may be disposed between the central panel 110 and at least one of the left panel 120 or the right panel 130, such that the rain deflector apparatus 100 is configurable to span a selected width greater than a combined width of the central panel 110 and the left and right panels 120, 130.

### B. Panel Structure

Each of the central panel 110, the left panel 120, the right panel 130, and any intermediary panels 140 includes a main body 150 that is a substantially flat sheet. The main body 150 includes a front face 152, a back face 154, and a thickness defining a top edge 156, a bottom edge 158, a right edge 160, and a left edge 162.

In embodiments, the thickness of the main body 150 varies between the top edge 156 and the bottom edge 158.

### C. Sealing Features

A bottom seal portion 170 extends from the bottom edge 158 of the main body 150 and spans substantially from the right edge 160 to the left edge 162.

A top sealing surface portion 180 is disposed adjacent to the top edge 156 and spans substantially from the right edge 160 to the left edge 162.

When the rain deflector apparatus 100 is installed, the bottom seal portion 170 and the top sealing surface portion 180 are configured to engage corresponding structural surfaces to maintain a sealing pressure that reduces intrusion of water.

### D. Attachment Mechanisms

One or more attachment mechanisms 190 are disposed on the back face 154 of the main body 150 between the top sealing surface portion 180 and the bottom seal portion 170. The attachment mechanisms 190 are configured to secure the rain deflector apparatus 100 to a structure.

In embodiments, the central panel 110 includes at least one track attachment mechanism 192 configured to secure the rain deflector apparatus 100 to a track.

### E. Telescoping and Mating Features

The panels 110, 120, 130, and any intermediary panels 140 include mating features 200 configured to constrain the panels relative to one another with respect to their top edges 156 and bottom edges 158 while permitting longitudinal translation of the panels relative to one another.

In this manner, the panels are slidingly coupled such that the rain deflector apparatus 100 is telescopically adjustable between a contracted configuration and an expanded configuration.

### F. End Panel Features

In embodiments, the left panel 120 and the right panel 130 include one or more attachment mechanisms 190 configured to secure the panels to a structure including a rail, a track, or another surface.

In embodiments, the left panel 120 and the right panel 130 further include one or more side wings 210 configured to attach the rain deflector apparatus 100 to a side structure.

### G. Side Wing Embodiment

In embodiments shown in the figures, the side wings 210 are coupled to the respective panels and are configured to articulate relative to the panels to engage adjacent structural surfaces.

### H. Intermediary Panel Characteristics

In embodiments, intermediary panels 140 are slidingly positioned between adjacent panels and do not include additional attachment mechanisms.

### I. Functional Operation

In operation, the rain deflector apparatus 100 is positioned such that the bottom seal portion 170 engages a floor or track and the top sealing surface portion 180 engages a door panel, thereby reducing intrusion of water by diverting water and debris away from the door and track.

### J. Retention Device

A retention device 300 is provided for use with a rain deflector apparatus 100, the rain deflector apparatus 100 including an extruded mounting portion 310.

The retention device 300 comprises a shaft portion 320 configured to be inserted into an end of the extruded mounting portion 310 and a head portion 330 coupled to the shaft portion 320, the head portion 330 having a diameter greater than the shaft portion 320.

The head portion 330 is configured to retain an accessory on the extruded mounting portion 310.

In embodiments, the shaft portion 320 is configured to be press-fit within the extruded mounting portion 310.

In embodiments, the shaft portion 320 is tapered to facilitate insertion into the extruded mounting portion 310.

In embodiments, the shaft portion 320 includes one or more deformable areas configured to deform upon insertion into the extruded mounting portion 310 to create a snug fit.

### K. Application Scope

Although described in the context of a sliding glass door system, the rain deflector apparatus 100 may be sized and configured for use with other structures including windows and other sliding door systems.

### CONCLUSION

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand various embodiments of the present invention, with various modifications as are suited to the particular use contemplated.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

1. A rain deflector apparatus comprising:
a plurality of panels including a central panel and at least one additional panel, the panels being configured to telescope relative to one another to adjust a width of the rain deflector apparatus;
each of the panels including a main body having a front face, a back face, and a thickness defining a top edge, a bottom edge, a right edge, and a left edge;
a bottom seal portion extending from the bottom edge of each of the panels;
a top sealing surface portion disposed adjacent to the top edge of each of the panels;
one or more attachment mechanisms disposed on the back face of at least one of the panels between the top sealing surface portion and the bottom seal portion; and
mating features configured to constrain relative movement between the panels with respect to the top edges and the bottom edges while permitting longitudinal translation of the panels relative to one another;
wherein the rain deflector apparatus is configurable to be secured to a structure such that the bottom seal portion and the top sealing surface portion engage corresponding surfaces to reduce intrusion of water.

2. The rain deflector apparatus of claim 1, wherein the plurality of panels further includes a left panel and a right panel disposed on opposite sides of the central panel.

3. The rain deflector apparatus of claim 1, further comprising one or more intermediary panels disposed between the central panel and the at least one additional panel.

4. The rain deflector apparatus of claim 3, wherein the one or more intermediary panels do not include attachment mechanisms.

5. The rain deflector apparatus of claim 1, wherein the bottom seal portion extends substantially from the right edge to the left edge of each panel.

6. The rain deflector apparatus of claim 1, wherein the top sealing surface portion extends substantially from the right edge to the left edge of each panel.

7. The rain deflector apparatus of claim 1, wherein the thickness of the main body varies between the top edge and the bottom edge.

8. The rain deflector apparatus of claim 1, wherein at least one of the panels includes a track attachment mechanism configured to secure the rain deflector apparatus to a track.

9. The rain deflector apparatus of claim 1, wherein at least one of the panels includes one or more side wings configured to attach the rain deflector apparatus to a side structure.

10. The rain deflector apparatus of claim 9, wherein the one or more side wings are configured to articulate relative to the at least one of the panels.

11. The rain deflector apparatus of claim 1, wherein the plurality of panels are slidingly coupled such that the rain deflector apparatus is adjustable between a contracted configuration and an expanded configuration.

12. The rain deflector apparatus of claim 1, wherein the rain deflector apparatus is configured to be secured to a sliding door track.

13. A retention device for use with the rain deflector apparatus of claim 1, the rain deflector apparatus including an extruded mounting portion, the retention device comprising:
a shaft portion configured to be inserted into an end of the extruded mounting portion; and
a head portion coupled to the shaft portion and having a diameter greater than the shaft portion,
wherein the head portion is configured to retain an accessory on the extruded mounting portion.

14. The retention device of claim 13, wherein the shaft portion is configured to be press-fit into the extruded mounting portion.

15. The retention device of claim 13, wherein the shaft portion is tapered.

16. The retention device of claim 13, wherein the shaft portion includes one or more deformable areas configured to deform upon insertion into the extruded mounting portion.

17. A system comprising:
a structure including a track and a movable panel; and
the rain deflector apparatus of claim 1 secured to the track,
wherein the rain deflector apparatus is positioned such that the bottom seal portion engages the track and the top sealing surface portion engages the movable panel to reduce intrusion of water.

18. A method of reducing water intrusion at a structural opening, the method comprising:
providing the rain deflector apparatus of claim 1;
positioning the rain deflector apparatus relative to a structure including a track and a movable panel; and
securing the rain deflector apparatus to the structure such that a bottom seal portion engages the track and a top sealing surface portion engages the movable panel to reduce intrusion of water.

19. The method of claim 18, further comprising adjusting a width of the rain deflector apparatus by translating the plurality of panels relative to one another.

20. The method of claim 18, wherein securing the rain deflector apparatus includes engaging one or more attachment mechanisms with the track.
